(19) United States
(12) Patent Application Publication
(10) Pub. No.: US 2002/0017634 A1
(43) Pub. Date: Feb. 14, 2002

(54) Electro-optical display, and liquid-crystal medium contained therein

(76) Inventors: Michael Heckmeier, Bensheim (DE); Herbert Plach, Darmstadt (DE); Hideo Ichinose, Kanagawa (JP); Shinji Nakajima, Kanagawa Pref (JP); Yasushi Sugiyama, Kanagawa-ken (JP); Akiko Takashima, Kanagawa Pref (JP)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 09/844,664

(22) Filed: Apr. 30, 2001

(30) Foreign Application Priority Data
Apr. 28, 2000 (DE) 10020814 2

(51) Int. Cl. C09K 19/20; C09K 19/34; C09K 19/30; C09K 19/12

(52) U.S. Cl. 252/299.67; 252/299.63; 252/299.61; 252/299.66; 428/1.1

(57) ABSTRACT

The invention relates to liquid-crystal media which comprise at least one compound selected from the group of the compounds of the formulae I to III

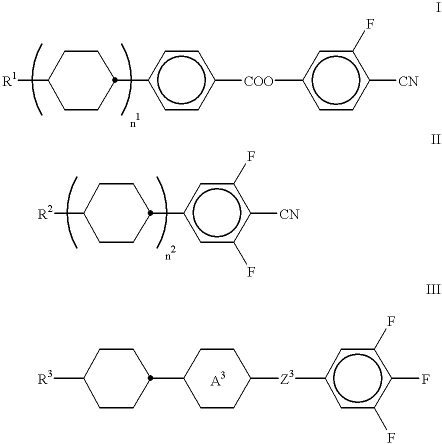

where the various parameters are as defined in the text, to the use of these media in electro-optical liquid-crystal displays, and to such liquid-crystal displays, in particular to displays which have homeotropically aligned liquid crystals and a horizontal electric field and contain these liquid-crystal media.

The present invention relates to active matrix-addressed liquid-crystal displays (AMDs or AM LCDs), in particular those which use an active matrix of thin-film transistors (TFTs) or of varistors. In addition, the present application relates to liquid-crystal media for use in such displays. Such AMDs can use various active electronic switching elements. Most widespread are displays using three-pole switching elements. These are also preferred in the present invention. Examples of such three-pole switching elements are MOS (metal oxide silicon) transistors or the abovementioned TFTs or varistors. In the case of TFTs, various semiconductor materials, predominantly silicon or cadmium selenide, are used. In particular, polycrystalline silicon or amorphous silicon is used. In contrast to the three-pole electronic switching elements, matrices of 2-pole switching elements, such as, for example, MIM (metal insulator metal) diodes, ring diodes or back-to-back diodes, can be employed in AMDs. Although these are also provided by the present application, they are, as explained in greater detail below, not preferred owing to the inferior electro-optical properties achieved by the AMDs.

In liquid-crystal displays of this type, the liquid crystals are used as dielectrics whose optical properties change reversibly on application of an electric voltage. Electro-optical displays which use liquid crystals as media are known to the person skilled in the art. These liquid-crystal displays use various electro-optical effects. The most common conventional displays use the TN effect (twisted nematic, having a nematic structure which is twisted by about 90°), the STN effect (supertwisted nematic) or the SBE effect (supertwisted birefringence effect). In these and similar electro-optical effects, liquid-crystalline media of positive dielectric anisotropy (Δε) are used.

Besides the abovementioned electro-optical effects which require liquid-crystal media of positive dielectric anisotropy, there are other electro-optical effects which use liquid-crystal media of negative dielectric anisotropy, such as, for example, the ECB effect (electrically controlled birefringence) and its subforms DAP (deformation of aligned phases), VAN (vertically aligned nematics) and CSH (colour super homeotropics).

The IPS effect (in-plane switching), which has been increasingly used recently, can use both dielectrically positive and dielectrically negative liquid-crystal media, similarly to guest/host displays, which, depending on the display mode used, can use dyes either in dielectrically positive or in dielectrically negative media.

An electro-optical effect which has been described recently (Kim, K. H., Park, S. B., Shim, J.-U., Chen, J. and Souk, J. H., International Display Workshop '97, p. 175 ff. (1997), Lee, S. H., Kim, Y. H., Jung, T. K., Park, I. C., Lee, Y. H., Rho, B. G., Park, J. S. and Park, H. S., International Display Workshop '97, p. 9 ff. (1997) and Liu, W., Kelly, J. and Chen, J., SID 98 Digest, p. 318-322 (1998)) combines the advantages of good brightness, viewing-angle dependence and response time of the VAN displays with the advantage of the IPS displays, the use of electrodes on only one substrate, also called interdigital electrodes. This effect uses dielectrically positive liquid-crystal media which are initially homeotropically aligned. The electrodes are on the same side as the liquid-crystal layer, resulting in the formation of a horizontal electrical field (HEF) which is substantially parallel to the liquid-crystal layer.

These displays use, like the abovementioned VAN displays, an optically negative compensation layer whose optical retardation is adapted to the optical retardation of the liquid-crystal layer and is usually identical to the latter.

The liquid-crystal media employed in the abovementioned liquid-crystal displays and all liquid-crystal displays utilizing similar effects generally consist predominantly and usually even almost exclusively of liquid-crystal compounds having the corresponding dielectric anisotropy, i.e. compounds of positive dielectric anisotropy in the case of dielectrically positive media and compounds of negative dielectric anisotropy in the case of dielectrically negative media. The reason for this is that the operating voltage should be as low as possible in displays in general, including in displays using these effects. Use is therefore made of liquid-crystal media of very large dielectric anisotropy which are generally composed predominantly of dielectrically positive liquid-crystal compounds and contain at most relatively small proportions of dielectrically neutral compounds.

In the respective types of media (dielectrically positive or dielectrically negative), use is typically made of at best significant amounts of dielectrically neutral liquid-crystal compounds, since in general the liquid-crystal displays must have the lowest possible addressing voltages. For this reason, liquid-crystal compounds having a dielectric anisotropy which is opposite in sign to the dielectric anisotropy of the medium are generally employed extremely sparingly or not at all.

An exception is formed here by liquid-crystalline media for MIM displays (metal insulator metal) [J. G. Simmons, Phys. Rev. Vol. 155 No. 3, pp. 657-660; K. Niwa et al., SID 84 Digest, pp. 304-307, June 1984], in which the liquid-crystal media are addressed on an active matrix of thin film transistors (TFD, thin film diodes). In this type of addressing, which utilizes the non-linear characteristic line of diode switching, a storage capacitor cannot be charged together with the electrodes of the liquid-crystal display elements (pixels), in contrast to TFT displays. Thus, in order to minimize the effect of the voltage drop during the addressing cycle, the highest possible base value of the dielectric constant is necessary. In dielectrically positive media, as employed, for example, in MIM-TN displays, the dielectric constant perpendicular to the molecular axis (ε⊥) must thus be as large as possible, since it determines the base capacity of the pixel. To this end, as in WO 93/01253, EP 0 663 502 and DE 195 21 483, compounds of negative dielectric anisotropy are used in the dielectrically positive liquid-crystal media, besides dielectrically positive compounds.

EP 0 394 419 proposes dielectrically positive liquid-crystal media for active matrix displays based on dielectrically neutral and dielectrically positive liquid-crystal compounds, which may optionally contain dielectrically negative compounds.

The liquid-crystal media of the prior art have relatively poor low-temperature stabilities. Thus, the nematic phases frequently extend only down to −20° C. and in some cases even only down to 0° C.

In addition, the threshold voltage (V₁₀) is simultaneously relatively high, often greater than 1.0 V and usually even greater than 1.3 V.

In particular when they have low threshold voltages, the majority of the liquid-crystal media of the prior art have relatively large values for Δn, frequently greater than 0.11, sometimes even significantly greater than 0.12 and predominantly greater than 0.10.

However, such large Δn values are not particularly advantageous for VA HEF displays having a typical optical retardation d·Δn of approximately 0.32 μm. Such large Δn values require very small layer thicknesses to be achieved, which are favourable for the response times observed, but result in low production yields.

It has hitherto been a problem to achieve the relatively small Δn values required at the same time as a very high polarity, i.e. high Δε.

There thus was and is a great demand for liquid-crystal media which do not have the disadvantages of the media of the prior art, or at least do so to a significantly reduced extent, and which simultaneously are suitable for use in conjunction with homeotropic edge alignment.

This is achieved by using the liquid-crystal media according to the invention.

The electro-optical displays according to the invention comprise liquid-crystal media which comprise

a) one or more strongly dielectrically positive compound(s) selected from the group of the compounds of the formulae I to III

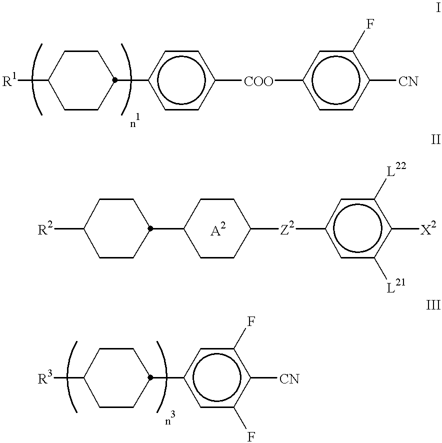

in which

R¹, R² and R³ are each, independently of one another, alkyl or alkoxy having 1 to 7 carbon atoms, preferably n-alkyl or n-alkoxy, particularly preferably having 1 to 5 carbon atoms, or alkenyl, alkoxyalkyl or alkenyloxy having 2 to 7 carbon atoms, preferably 1E-alkenyl, unbranched alkoxylalkyl or alkenyloxy, particularly preferably having 2 to 4 carbon atoms,

n¹ is 0 or 1,

n³ is 1 or 2, and

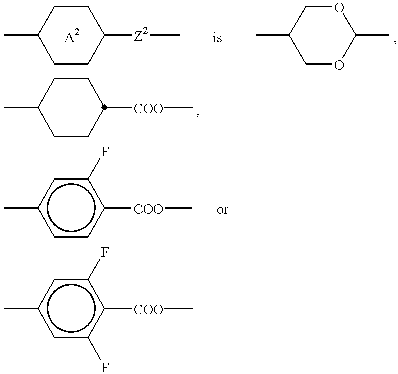

X² is F, Cl, OCF₂H or OCF₃, and

L²¹ and L²² are H or F;

and optionally

b) one or more dielectrically positive compound(s) of the formula IV

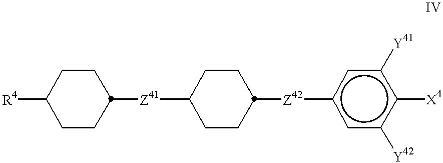

in which

R⁴ is as defined above for R¹ under the formula I, and

Z⁴¹ is —CH₂—CH₂—, —CF₂—O—, —O—CF₂— or a single bond, preferably —CH₂—CH₂— or a single bond, preferably a single bond,

Z⁴² is —COO—, —CH₂—CH₂—, —CF₂—O—, —O—CF₂— or a single bond, preferably —COO—, —CH₂—CH₂— or a single bond, preferably —COO— or a single bond,

X⁴ is F, Cl, OCF₂H or OCF₃, preferably F, OCF₂H or OCF₃, and

Y⁴¹ and Y⁴² are each, independently of one another, H or F,

where, in the case where X⁴=F, preferably at least one of Y⁴¹ and Y⁴² is F, and preferably both Y⁴¹ and Y⁴² are F,

and optionally

c) one or more dielectrically positive compound(s) of the formula V

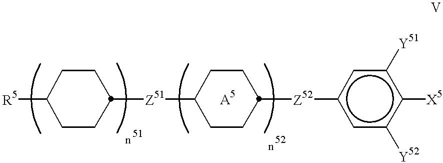

in which

R⁵ is as defined above for R¹ under the formula I, and

Z⁵¹ and Z⁵² are each, independently of one another, —CH₂CH₂— or a single bond, preferably a single bond,

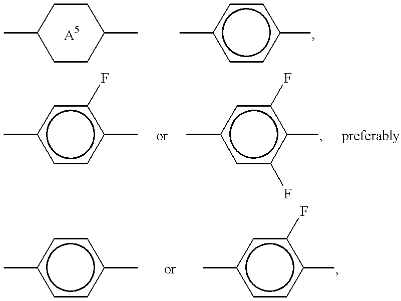

X⁵ is F, Cl, OCF₂H or OCF₃, preferably F, OCF₂H or OCF₃, and

n⁵² is 0 or 1,

n⁵¹ is 1 and, in the case where n⁵²=1, is also 2;

and optionally

d) one or more dielectrically positive compound(s) of the formula VI

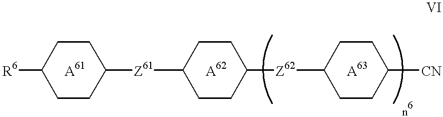

in which

R⁶ is as defined above for R¹ under the formula I, and

Z⁶¹ and Z⁶² are each, independently of one another, —CH₂CH₂—, —COO— or a single bond, preferably —CH₂CH₂— or a single bond, particularly preferably a single bond,

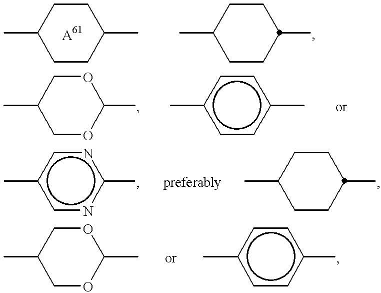

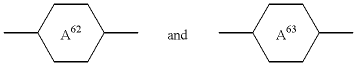

are each, independently of one another,

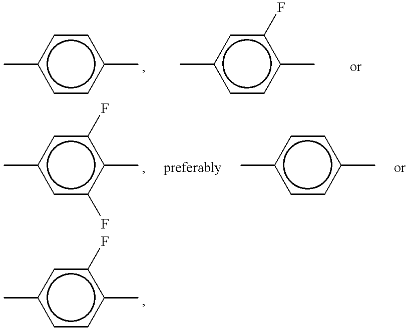

n⁶ is 0 or 1, preferably 0;

and optionally

e) one or more dielectrically neutral compound(s) of the formula VII

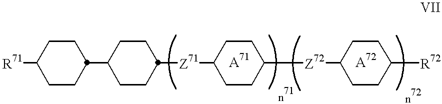

in which

R⁷¹ and R⁷² are each, independently of one another, as defined above for R¹ under the formula I, and

Z⁷¹ and Z⁷² are each, independently of one another, —COO—, —CH₂CH₂— or a single bond, preferably —COO— or a single bond, particularly preferably at most one of the two being —COO—,

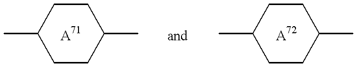

are each, independently of one another,

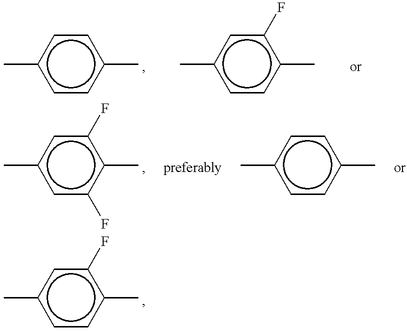

particularly preferably, if present, at least one being

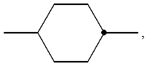

n⁷¹ and n⁷² are each, independently of one another, 0 or 1;

and optionally

f) one or more dielectrically neutral compound(s) of the formula VIII

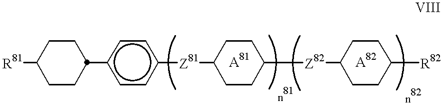

in which

R⁸¹ and R⁸² are each, independently of one another, as defined above for R¹ under the formula I, and

Z⁸¹ and Z⁸² are each, independently of one another, —COO—, —CH₂CH₂— or a single bond, preferably —COO— or a single bond, particularly preferably a single bond,

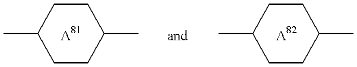

are each, independently of one another,

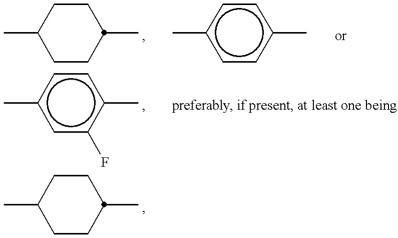

and

n⁸¹ and n⁸² are each, independently of one another, 0 or 1,

the compounds of the formula VII being excluded from inclusion in the compounds of formula VIII.

The liquid-crystal media preferably comprise in each case one or more compound(s) of at least one formula, preferably two or more different formulae, selected from the group consisting of the compounds of the formulae Ia, Ib, II1 to II3, IIIa and IIIb

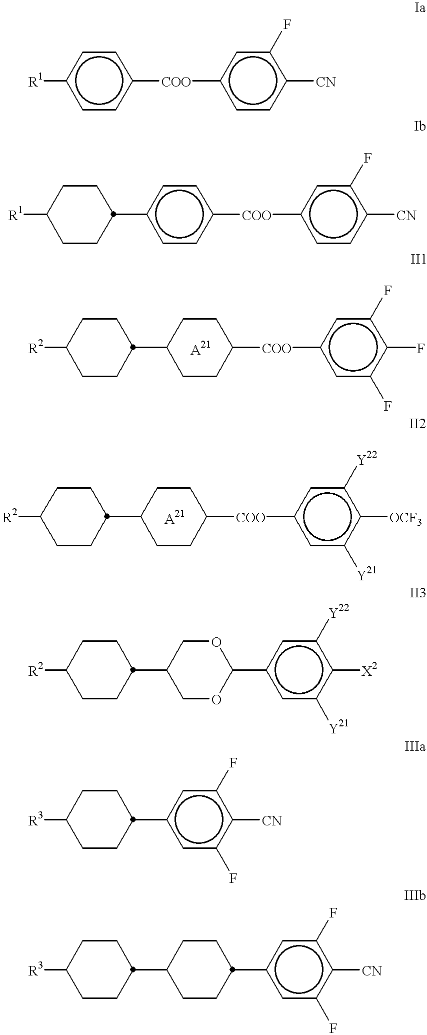

in which the parameters are as defined above under the respective formulae (I to III).

The compounds of the formula II1 are preferably selected from the group consisting of the compounds II1a to II1d:

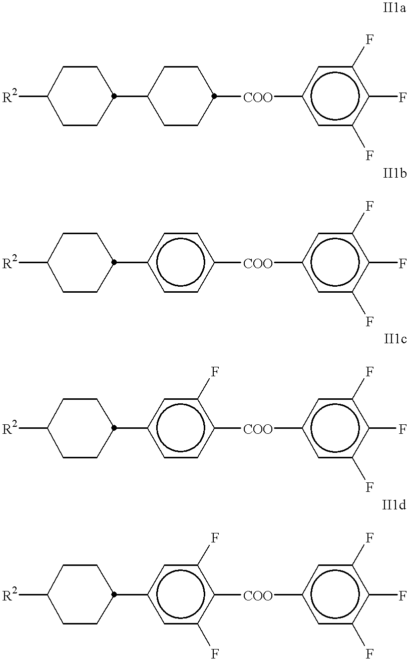

in which R² is as defined above under formula II1. Particular preference is given to compounds of the formula II1a and/or II1c.

Preference is given to the compounds of the formula II2 selected from the group consisting of the compounds II2a to II2h

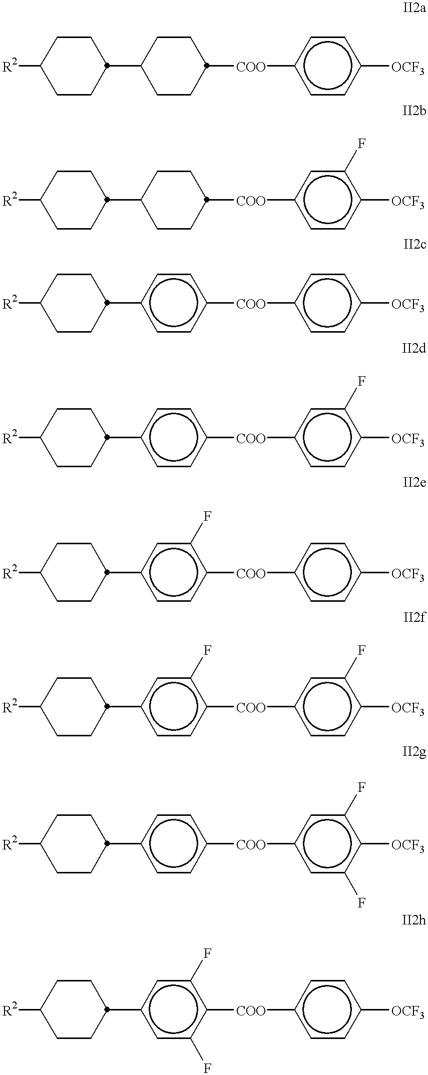

in which R² is as defined above under formula II2. Particular preference is given to compounds of the formula II2d.

Preference is given to the compounds of the formula II3 selected from the group consisting of the compounds of the formulae II3a to II3c

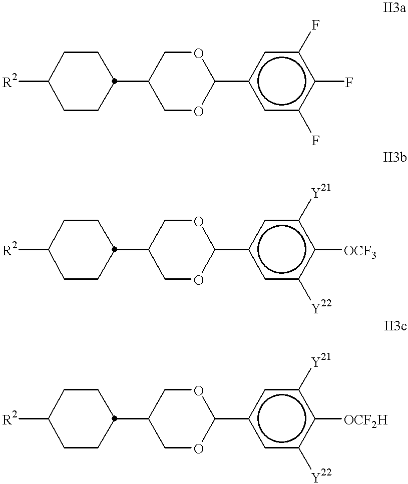

in which R³ is as defined above under formula II3. Particular preference is given to compounds of the formula II3a.

Preference is given to the compounds of the formula IV selected from the group consisting of the compounds of the formulae IV1 to IV4

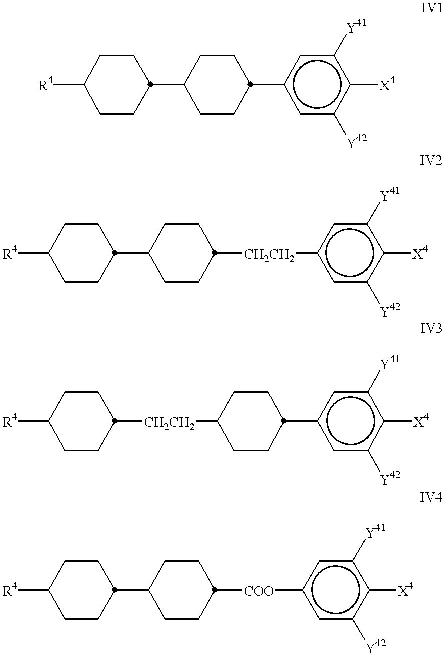

in which the parameters are as defined above under formula IV. Particular preference is given to compounds of the formula IV1 and/or IV4.

Preference is given to the compounds of the formula IV1 selected from the group consisting of the compounds of the formulae IV1a to IV1f

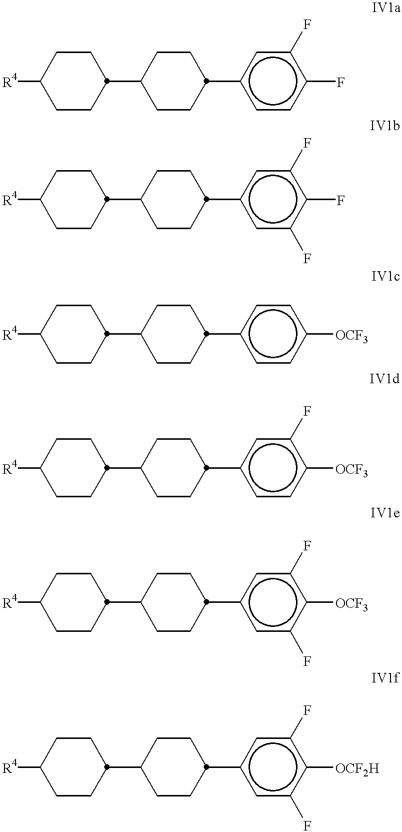

in which R⁴ is as defined above under formula IV1. Particular preference is given to compounds of the formula IV1a in which R⁴ is preferably alkenyl, of the formulae IV1b, IV1c and/or IV1f.

Preference is given to the compounds of the formula IV2 selected from the group consisting of the compounds of the formulae IV2a to IV2e

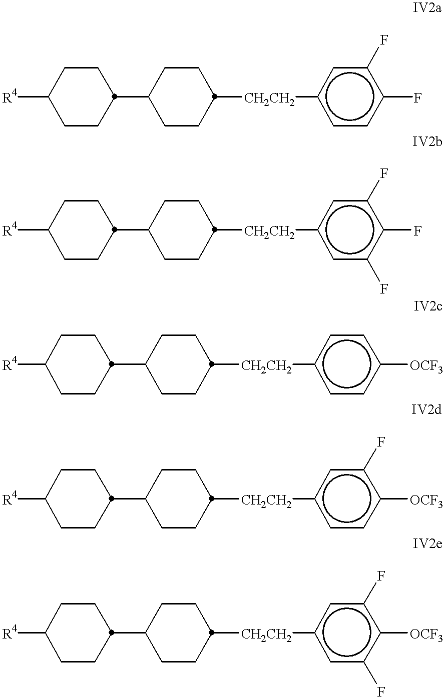

in which R⁴ is as defined above under formula IV2. Particular preference is given to compounds of the formula IV2a, IV2b and/or IV2d.

Preference is given to the compounds of the formula IV3 selected from the group consisting of the compounds of the formulae IV3a to IV3e

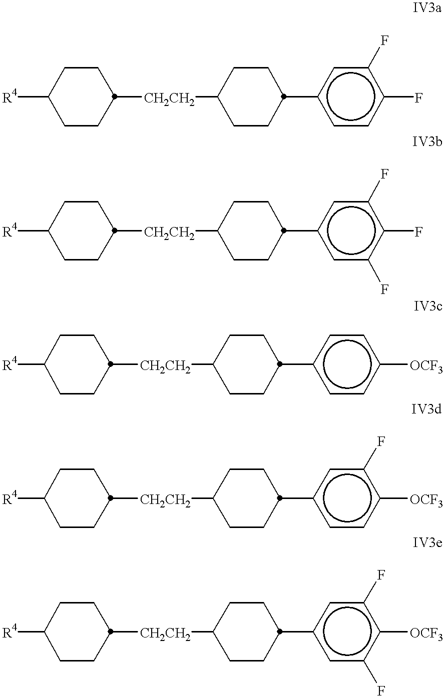

in which R⁴ is as defined above under formula IV3. Particular preference is given to compounds of the formula IV3a and/or IV3b.

Preference is given to the compounds of the formula IV4 selected from the group consisting of the compounds of the formulae IV4a to IV4e

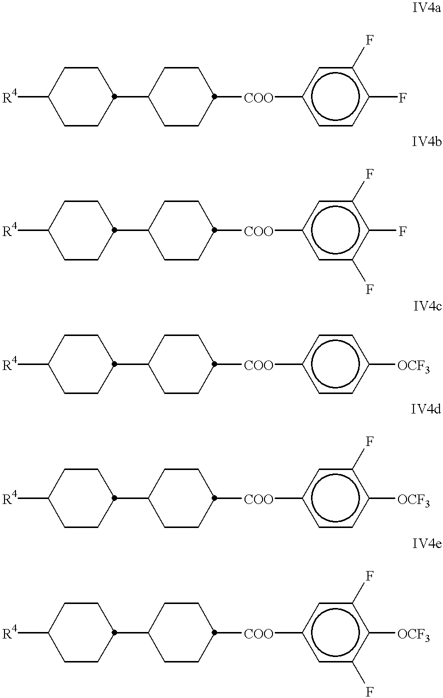

in which R⁴ is as defined above under formula IV4. Particular preference is given to compounds of the formula IV4c.

Preference is given to the compounds of the formula V selected from the group consisting of the compounds of the formulae V1 to V3

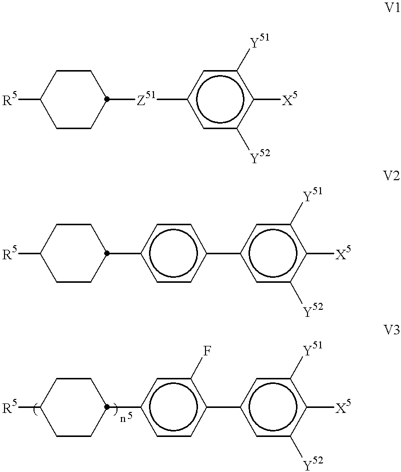

in which the parameters are as defined above under formula V.

Preference is given to the compounds of the formula V1 selected from the group consisting of the compounds of the formulae V1a to V1f

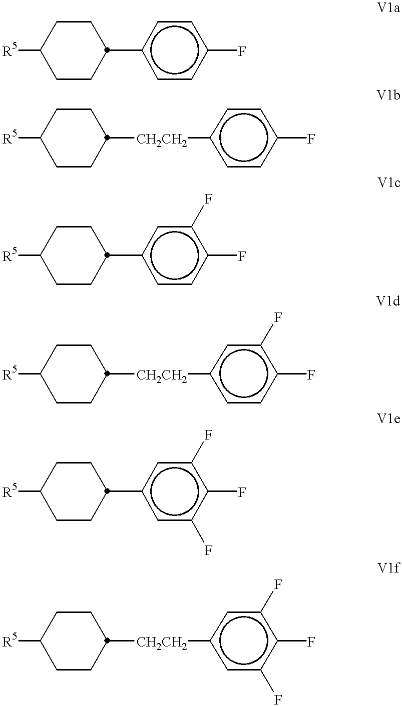

in which R⁵ is as defined above under formula V1. Particular preference is given to compounds of the formula V1a, V1d and/or V1e and very particularly preferably of the formula V1a.

Preference is given to the compounds of the formula V2 selected from the group consisting of the compounds of the formulae V2a to V2d

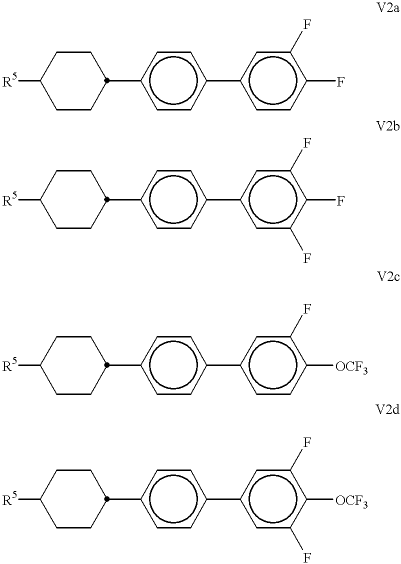

in which R⁵ is as defined above under formula V2. Particular preference is given to compounds of the formula V2b.

Preference is given to the compounds of the formula V3 selected from the group consisting of the compounds of the formulae V3a to V3f

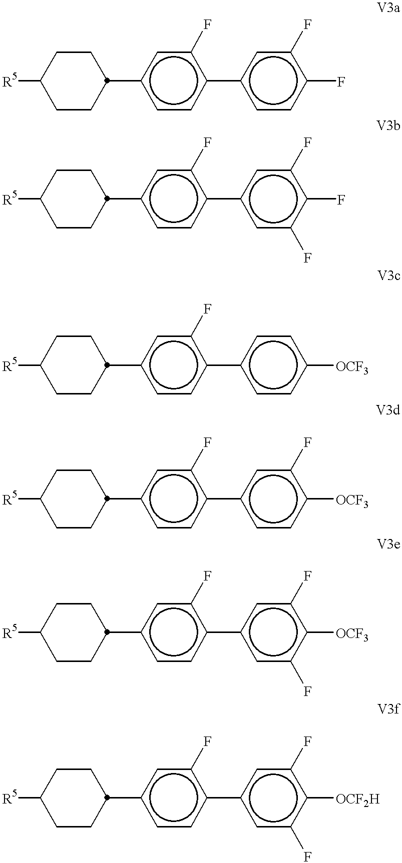

in which R⁵ is as defined above under formula V3. Particular preference is given to compounds of the formula V3b.

Preference is given to the compounds of the formula VI selected from the group consisting of the compounds of the formulae VI1 and VI2

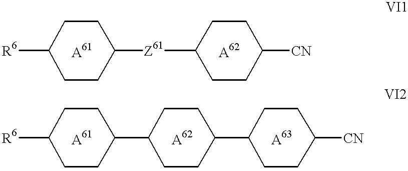

in which the parameters are as defined above under formula VI. Particular preference is given to compounds of the formula VI1.

Preference is given to the compounds of the formula VI1 selected from the group consisting of the compounds of the formulae VI1a to VI1d

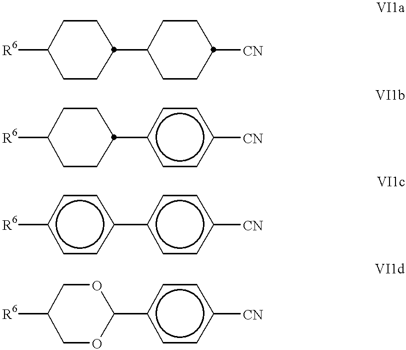

in which R⁶ is as defined above under formula VI. Particular preference is given to compounds of the formula VI1a, VI1b and/or VI1d and very particularly preferably of the formula VI1a and/or VI1d.

Preference is given to the compounds of the formula VI2 selected from the group consisting of the compounds of the formulae VI2a and VI2b

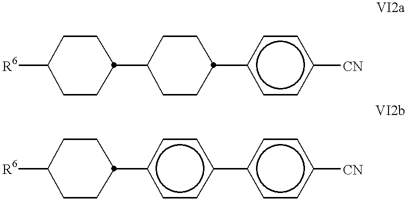

in which R⁶ is as defined above under formula VI. Particular preference is given to compounds of the formula VI2a.

Preference is given to the compounds of the formula VII selected from the group consisting of the compounds of the formulae VII1 to VII3

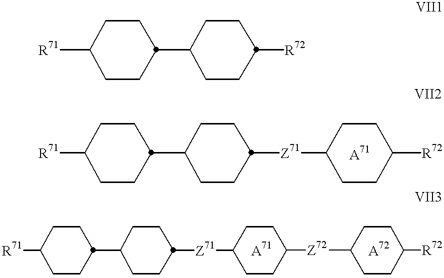

in which the parameters are as defined above under formula VII.

Preference is given to the compounds of the formula VII1 selected from the group consisting of the compounds of the formulae VII1a to VII1d

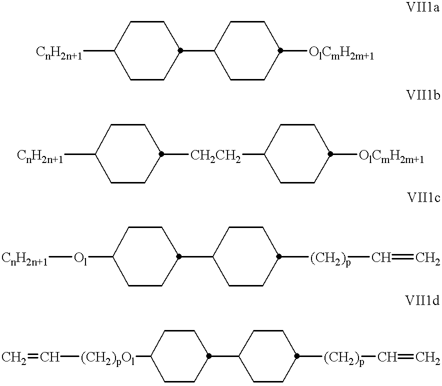

in which, in each case independently of one another,

n and m are each an integer from 1 to 7, preferably from 1 to 5,

l is 0 or 1, preferably 0, and

p and q are each an integer from 0 to 3, preferably 0 or 1.

Preference is given to the compounds of the formula VII2 selected from the group consisting of the compounds of the formulae VII2a to VII2d

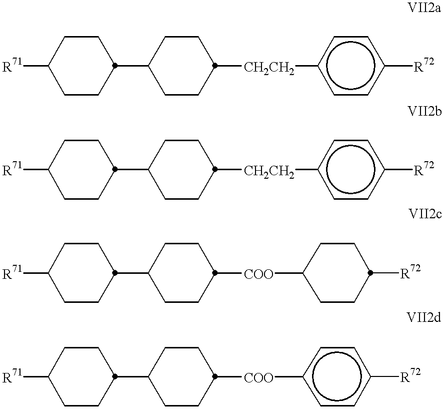

in which R⁷¹ and R⁷² are as defined above under formula VII2.

Preference is given to the compounds of the formula VII3 selected from the group consisting of the compounds of the formulae VII3a to VII3c

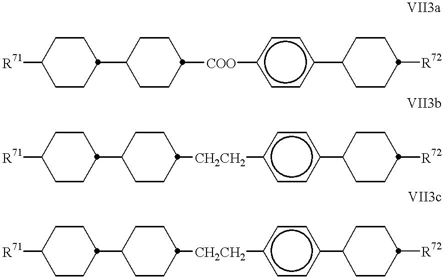

in which R⁷¹ and R⁷² are as defined above under formula VII3.

Preference is given to the compounds of the formula VIII selected from the group consisting of the compounds of the formulae VIII1 to VIII3

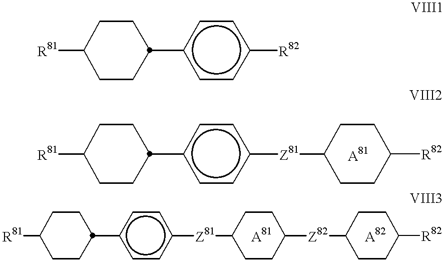

in which R⁸¹ and R⁸² are as defined above under formula VIII.

Preference is given to the compounds of the formula VIII1 selected from the group consisting of the compounds of the formulae VIII1a to VIII1d

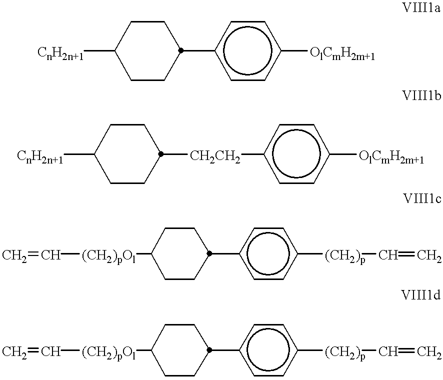

in which, in each case independently of one another,

n and m are each an integer from 1 to 7, preferably from 1 to 5,

l is 0 or 1, preferably 0, and

p and q are each an integer from 0 to 3, preferably 0 or 1.

Preference is given to the compounds of the formula VIII2 selected from the group consisting of the compounds of the formulae VIII2a and VIII2b

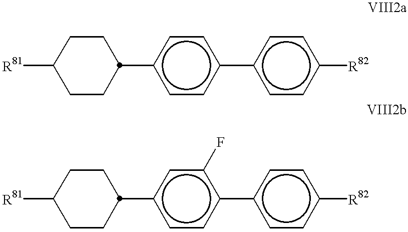

in which R⁸¹ and R⁸² are as defined above under formula VIII2.

Preference is given to the compounds of the formula VIII3 selected from the group consisting of the compounds of the formulae VIII3a and VIII3b

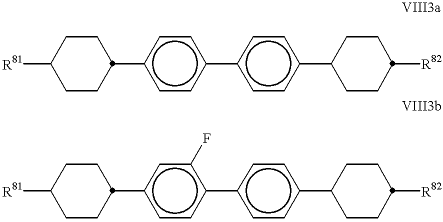

in which R⁸¹ and R⁸² are as defined above under formula VIII3.

In a first preferred embodiment, the liquid-crystal medium comprises

a₁) one or more strongly dielectrically positive compound(s) selected from the group consisting of the compounds of the formulae I and II

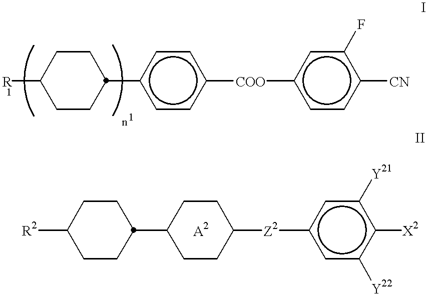

in which the parameters are as defined above under the respective formulae, and

Z² is preferably —COO—, and

b₁) one or more compound(s) selected from the group consisting of the dielectrically positive compounds of the formulae IV to VI and the dielectrically neutral compounds of the formulae VII and VIII

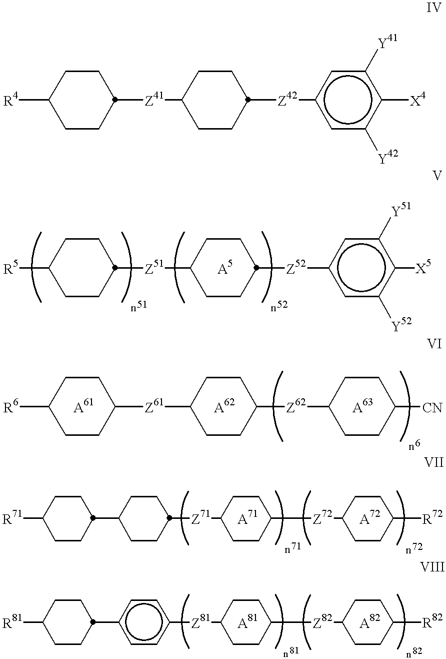

in which the parameters are as defined above under the respective formulae (IV to VIII).

In a first preferred sub-embodiment of this embodiment, the liquid-crystal medium comprises

a₁₁) one or more strongly dielectrically positive compound(s) of the formula I

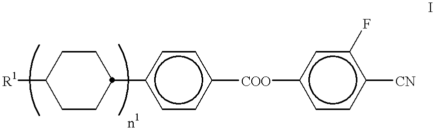

in which the parameters are as defined above under formula I,

preferably selected from the group consisting of the compounds of the formulae Ia and Ib, and particularly preferably in each case one or more compound(s) both of the formula Ia and of the formula Ib

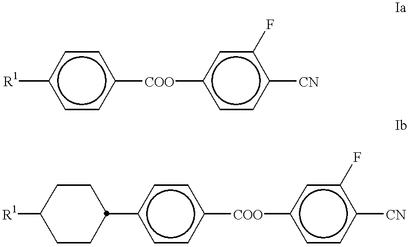

in which the parameters are as defined above under the respective formulae (Ia and Ib), and

b₁₁) one or more dielectrically neutral compound(s) of the formula VII

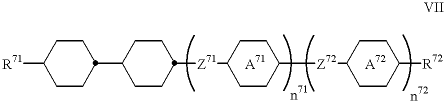

in which the parameters are as defined above under formula VII,

preferably selected from the group consisting of the compounds of the formulae VII1 to VII3

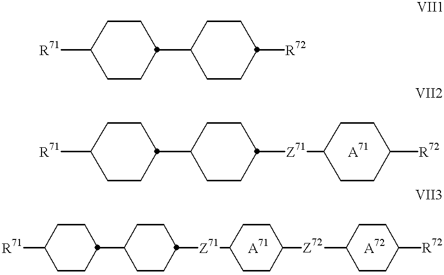

in which the parameters are as defined above under formula VII.

In this preferred sub-embodiment, the liquid-crystal medium preferably comprises

one or more compound(s) selected from the group consisting of the compounds of the formulae Ia and Ib, preferably in a total concentration of from 20% to 60% and particularly preferably from 30% to 50%, and/or

one or more, preferably two to five, compound(s) of the formula Ia in a total concentration of preferably from 10% to 45%, particularly preferably from 15% to 35%, and very particularly preferably from 17% to 26%, and/or

one or more, preferably two to four, compound(s) of the formula Ib in a total concentration of preferably from 5% to 30%, particularly preferably from 8% to 22%, and very particularly preferably from 10% to 20%, and/or

one or more, preferably four to ten, compound(s) of the formula VII, preferably in a total concentration of from 40% to 80% and particularly preferably from 50% to 70%, and/or

one or more, preferably two to six, compound(s) of the formula VII1, preferably in a total concentration of from 30% to 70% and particularly preferably from 40% to 60%, and/or

one or more, preferably two to five, compound(s) of the formula VII2, preferably in a total concentration of from 4% to 30% and particularly preferably from 8% to 20%, and/or

optionally one or more, preferably two to five, compound(s) of the formula VII3, preferably in a total concentration of from 3% to 20% and particularly preferably from 5% to 15%.

In this preferred sub-embodiment, the liquid-crystal medium comprises, in total, preferably at most 20%, particularly preferably less than 15%, very particularly preferably less than 10% and most preferably less than 5% of compounds which are not covered by the formulae I and VII.

In a second preferred sub-embodiment, the liquid-crystal medium comprises

a₁₂) one or more strongly dielectrically positive compound(s) of the formula II

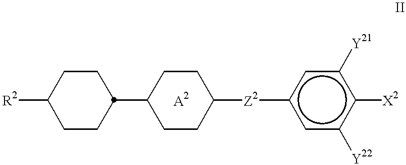

in which the parameters are as defined above under formula II,

preferably selected from the group consisting of the compounds of the formulae II1 to II3, particularly preferably of the formula II1

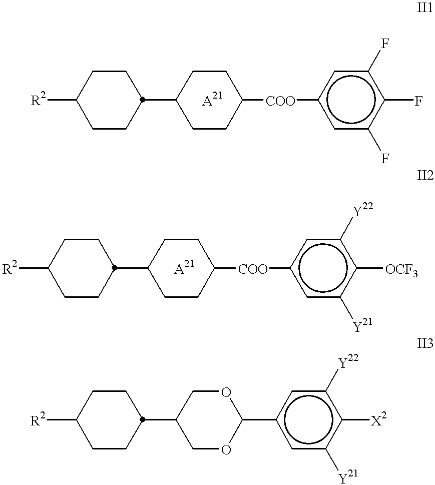

in which the parameters are as defined above under the respective formulae (II1 to II3),

and particularly preferably one or more compound(s) selected from the group consisting of the compounds of the formulae II1a to II1d, II2a to II2e and II3a to II3c, very particularly preferably selected from the group consisting of the compounds of the formula II1a and/or II1c, optionally additionally II2d and/or II3a

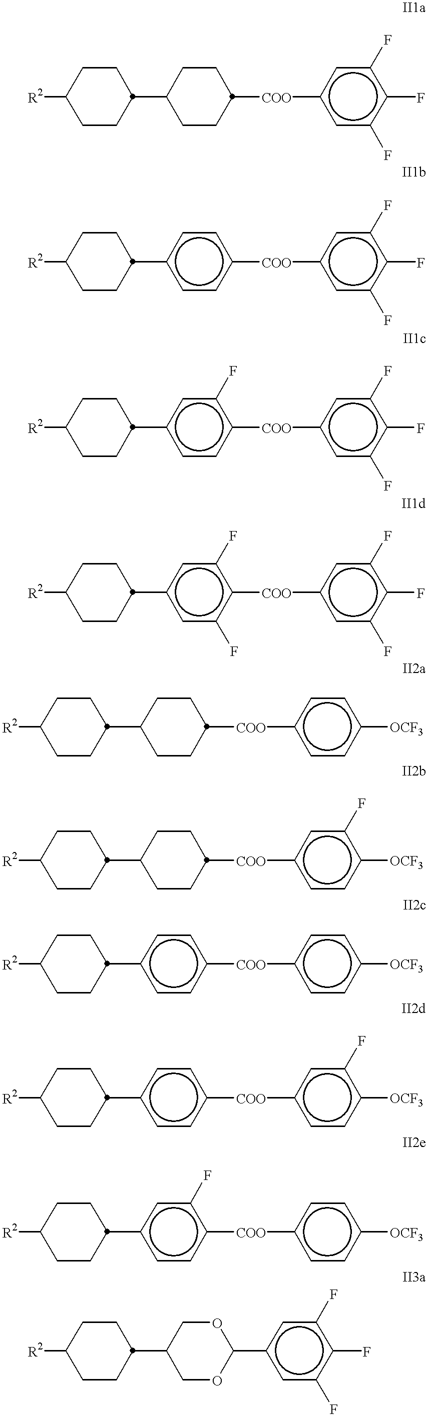

in which the parameters are as defined above under the respective formulae,

b₁₂) optionally one or more strongly dielectrically positive compound(s) selected from the group consisting of the compounds of the formulae I and III

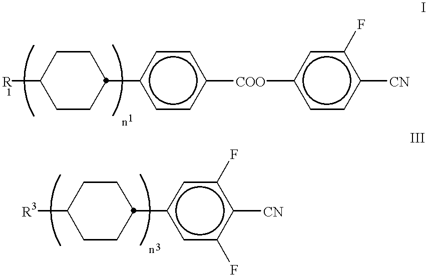

in which the parameters are as defined above under the respective formulae (I and III),

preferably selected from the group consisting of the compounds of the formulae Ia, Ib, IIIa and IIIc, particularly preferably selected from the group consisting of the compounds of the formulae Ia and IIIa,

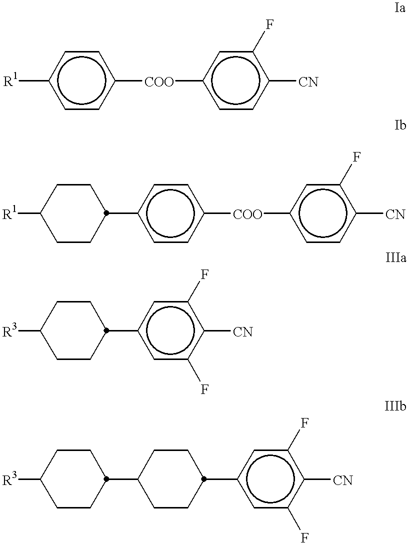

in which the parameters are as defined above under the respective formulae (Ia, Ib, IIIa and IIIb),

c₁₂) optionally one or more dielectrically positive compound(s) selected from the group consisting of the compounds of the formulae IV and V

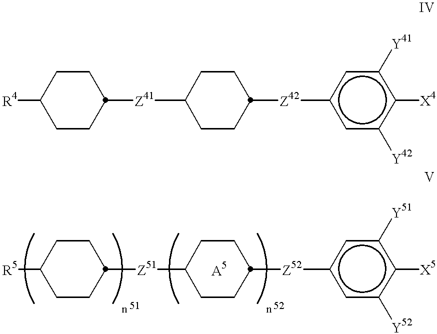

in which the parameters are as defined above under the respective formulae (IV and V), preferably one or more compounds of at least one of the formulae IV and V, particularly preferably in each case at least one compound of the formula IV and of the formula V, and

d₁₂) optionally one or more dielectrically positive compound(s) of the formula VI

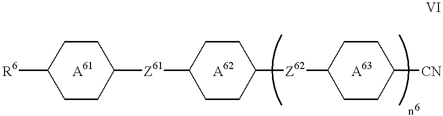

in which the parameters are as defined above under formula VI,

e₁₂) optionally one or more dielectrically neutral compound(s) selected from the group consisting of the compounds of the formulae VII and VIII, preferably of the formula VII,

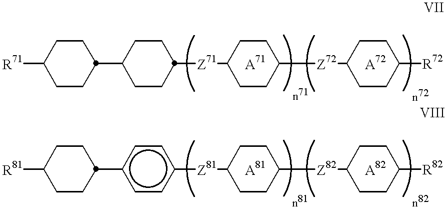

in which the parameters are as defined above under the respective formulae (VII and VIII).

In this second preferred sub-embodiment, the liquid-crystal medium preferably comprises

one or more compound(s) of the formula II, preferably selected from the group consisting of the compounds of the formulae IIa, IIc, II2d and II3a, preferably in a total concentration of from 10% to 70%, particularly preferably from 20% to 60%, and very particularly preferably from 25% to 55%, and/or

optionally one or more, preferably one to four, compound(s) of the formula I, preferably of the formula Ia, in a total concentration of preferably from 0% to 25%, particularly preferably from 2% to 20%, and very particularly preferably from 4% to 15%, and/or

optionally one or more, preferably one to three, compound(s) of the formula III, preferably of the formula IIIa, in a total concentration of preferably from 0% to 30%, particularly preferably from 5% to 25%, and very particularly preferably from 10% to 20%, and/or

optionally one or more, preferably two to five, compound(s) selected from the group consisting of the compounds of the formulae IV and V, preferably obligatorily of at least one of the formulae IV or V and particularly preferably obligatorily both of the formula IV and of the formula V, in a total concentration of preferably from 0% to 80%, particularly preferably from 10% to 75%, and very particularly preferably from 15% to 70%, and/or

optionally one or more, preferably one to four, compound(s) of the formula VI, preferably selected from the group consisting of the compounds of the formulae VI1a and VI1d, in a total concentration of preferably from 0% to 49%, particularly preferably from 10% to 45%, and very particularly preferably from 31% to 39%, and/or optionally one or more, preferably four to ten, compound(s) selected from the group consisting of the compounds of the formulae VII and VIII, preferably of the formula VII, preferably in a total concentration of from 0% to 40%, particularly preferably from 3% to 30%, and very particularly preferably from 4% to 21%.

In this preferred sub-embodiment, the liquid-crystal medium comprises, in total, preferably at most 20%, particularly preferably less than 15%, very particularly preferably less than 10% and most preferably less than 5% of compounds which are not covered by the formulae I to VIII.

According to this preferred sub-embodiment, the liquid-crystal medium preferably comprises

one or more compound(s) of the formula II, preferably selected from the group consisting of the compounds of the formulae IIa, IIc, II2d and II3a, particularly preferably of the formula II1a, preferably in a total concentration of from 10% to 50%, particularly preferably from 20% to 40%, and very particularly preferably from 25% to 35%, and

optionally, preferably obligatorily, one or more, preferably one to three, compound(s) of the formula I, preferably of the formula Ia, in a total concentration of preferably from 1% to 15%, particularly preferably from 2% to 12%, and very particularly preferably from 4% to 9%, and

optionally, preferably obligatorily, one or more compounds of the formula III, preferably of the formula IIIa, in a total concentration of preferably from 5% to 25%, particularly preferably from 8% to 19%, and very particularly preferably from 11% to 18%, namely

one or more compounds selected from the group consisting of the compounds of formulae I and III, preferably both of the formula I and III, and

optionally, preferably obligatorily, one or more compounds of the formula III, preferably of the formula IIIa, in a total concentration of preferably from 5% to 25%, particularly preferably from 8% to 19%, and very particularly preferably from 11% to 18%, and

optionally one or more compounds of the formula V, preferably of the formula Va and/or the formula Vd, in a total concentration of preferably from 0% to 40%, particularly preferably from 20% to 35%, and very particularly preferably from 23% to 33%, and

optionally, preferably obligatorily, one or more compounds of the formula VII, preferably selected from the group consisting of the compounds of the formulae III1 to III3, in a total concentration of preferably from 0% to 30%, particularly preferably from 3% to 26%, and very particularly preferably from 5% to 9%,

or

one or more compound(s) of the formula II, preferably selected from the group consisting of the compounds of the formulae IIa and IIc, particularly preferably either of the formula II1a or of the formula II1c, preferably in a total concentration of from 10% to 50%, particularly preferably from 20% to 40%, and very particularly preferably from 25% to 35%, and

optionally one or more compound(s) of the formula IId, preferably in a total concentration of from 0% to 30%, particularly preferably from 6% to 24%, and very particularly preferably from 9% to 14%, and

one or more compound(s) selected from the group consisting of the compounds of the formulae IV and V, preferably both of the formula IV and of the formula V, preferably in a total concentration of from 40% to 80%, particularly preferably from 45% to 75%, and very particularly preferably from 60% to 73%, and

optionally one or more compound(s) selected from the group consisting of the compounds of the formulae VII and VIII, preferably of the formula VII, preferably in a total concentration of from 0% to 15%, particularly preferably from 1% to 10%, and very particularly preferably from 3% to 9%.

If the liquid-crystal media according to the invention comprise compounds of the formula IV1a, R⁴ is in these compounds preferably ethyl, n-propyl, n-butyl, n-pentyl, vinyl or 1E-propenyl, particularly preferably vinyl or 1E-propenyl.

Owing to their Δn which is relatively high for application purposes, the compounds of the formula V, in particular those of the group consisting of the formulae V1 to V3, are usually used at most in relatively small amounts. An exception among these compounds is formed by compounds of the formula V3, in particular of the formula V3b, which can be used in relatively large amounts and are preferably used owing to their high Δε and their comparatively small Δn.

The compounds of the formula VIII also have relatively high birefringence values and are preferably used at most in relatively small amounts of typically up to 10%, preferably up to 5%.

Furthermore, the liquid-crystal media according to all preferred embodiments preferably comprise one or more compounds selected from the group consisting of the compounds of the formulae VII1a to VII1d, VII2a to VII2e and VII3a and VII3b:

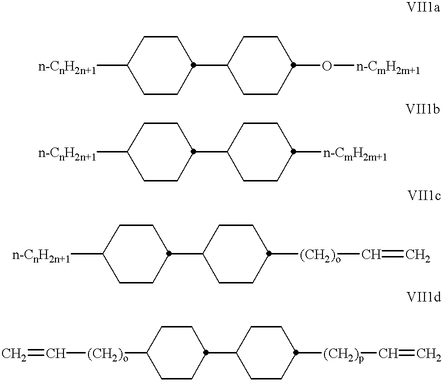

in which n and m are each, independently of one another, from 1 to 5, and o and p are each, both independently thereof and independently of one another, from 0 to 3,

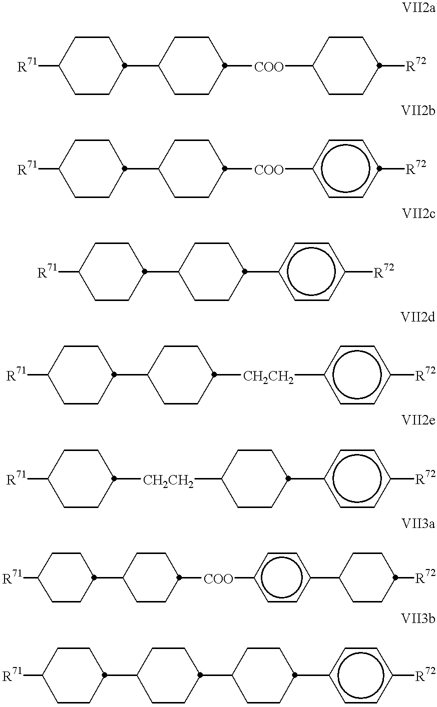

in which R⁷¹ and R⁷² are each as defined above under the formula VII1, and the phenyl rings may optionally be fluorinated. R⁷¹ is preferably n-alkyl having 1 to 5 carbon atoms, particularly preferably having 1 to 3 carbon atoms, and R⁷² is preferably n-alkyl or n-alkoxy having 1 to 5 carbon atoms or alkenyl having 2 to 5 carbon atoms. Of these, particular preference is given to compounds selected from the group consisting of the compounds of the formulae VII1a to VII1d, VII2a and VII3b. The liquid-crystal media optionally comprise one or more compounds selected from the group consisting of the compounds of the formulae VIIIa to VIIIc:

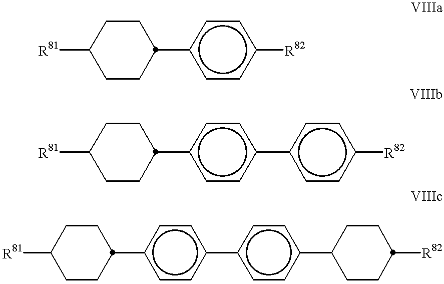

in which R⁸¹ and R⁸² are each as defined above under the formula VIII, and the phenyl rings may optionally be fluorinated. R⁸¹ is preferably n-alkyl having 1 to 5 carbon atoms, particularly preferably having 1 to 3 carbon atoms, and R⁸² is preferably n-alkyl or n-alkoxy having 1 to 5 carbon atoms or alkenyl having 2 to 5 carbon atoms. Of these, particular preference is given to compounds selected from the group consisting of the compounds of the formulae VIIIa and VIIIc.

The liquid-crystal media according to the invention preferably have nematic phases of in each case at least from −20° C. to 65° C., preferably from −30° C. to 70° C., very particularly preferably from −40° C. to 80° C. The term “having a nematic phase” here means firstly that no smectic phase and no crystallization are observed at low temperatures at the corresponding temperature, and secondly that no clearing occurs during heating from the nematic phase. Testing at low temperatures is carried out in a flow viscometer at the corresponding temperature, and checked by storage in test cells having an appropriate layer thickness for electro-optical use, for at least 100 hours. At high temperatures, the clearing point is measured by conventional methods in capillaries.

The liquid-crystal media according to the invention are furthermore characterized by relatively low optical anisotropy values. The birefringence values are preferably in the range from 0.050 to 0.120, particularly preferably in the range from 0.065 to 0.100 and very particularly preferably in the range from 0.075 to 0.090:

In addition, the liquid-crystal media according to the invention have small threshold voltage values of less than or equal to 1.5 V, preferably less than or equal to 1.0 V, particularly preferably less than or equal to 0.9 V, very particularly preferably less than or equal to 0.8 V.

These preferred values for the individual physical properties are also maintained when in each case combined with one another. Thus, media according to the invention have, in particular, the following property combinations:

| | Nematic | Nematic | | |
|---|---|---|---|---|
| | lower limit | upper limit | | |
| | of Phase | of Phase | | Threshold |
| | T/° C. | T/° C. | Δn | voltage/V |
| According to | ≦−20 | ≧65 | ≦0.095 | ≦1.0 |
| the invention | | | | |
| Preferred | ≦−30 | ≧70 | ≦0.090 | ≦0.9 |
| Particularly | ≦−40 | ≧80 | ≦0.088 | ≦0.8 |
| preferred | | | | |

where, as throughout the application, “≦” means less than or equal to and “≧” means greater than or equal to.

Particularly preferably, the abovementioned preferred concentration ranges also apply to this preferred combination of compounds.

The individual compounds are usually employed in concentrations of from 1% to 25%, preferably from 2% to 23%, particularly preferably from 3% to 19%.

Independently of the abovementioned limits for the total amount of the compounds of the formula I, compounds of the formula Ia are employed in these liquid-crystal media in a concentration of from 1% to 15%, preferably from 2% to 14%, particularly preferably from 2% to 8%. The compounds having relatively short alkyl chains, in particular ethyl and propyl, are preferably used in a lower concentration than the compounds having relatively long alkyl chains, in particular butyl, pentyl and heptyl.

In the present application, the term “compounds” means both one and a plurality of compounds, which is generally specially emphasized by using the notation “compound(s)”.

In the present application, the term “dielectrically positive compounds” is taken to mean compounds having a Δεof >1.5, the term “dielectrically neutral compounds” is taken to mean compounds in which −1.5≦Δε≦1.5, and “dielectrically negative compounds” is taken to mean compounds in which Δε is <−1.5. The dielectric anisotropy of the compounds is determined here by dissolving 10% of the compounds in a liquid-crystalline host and determining the capacitance of this mixture at 1 kHz in at least one test cell each with a thickness of 10 μm and a homeotropic and homogeneous surface alignment. The measurement voltage is typically from 0.5 V to 1.0 V, but is always less than the capacitive threshold of the respective liquid-crystal mixture.

The host mixture used for dielectrically positive compounds is ZLI-4792 and that used for dielectrically neutral and dielectrically negative compounds is ZLI-3086, both from Merck KGaA, Germany. The values for the respective compounds to be investigated are obtained from the change in dielectric constants of the host mixture after addition of the compound to be investigated and extrapolation to 100% of the compound employed.

The term “threshold voltage” in the present application relates to the optical threshold for 10% relative contrast (V₁₀), unless explicitly stated otherwise.

However, in relation to the liquid-crystal mixtures of negative dielectric anisotropy, the term “threshold voltage” is used in the present application for the capacitive threshold voltage (V₀), also known as the Freedericksz threshold, unless explicitly stated otherwise.

All concentrations in this application, unless explicitly stated otherwise, are given in percent by weight and relate to the corresponding mixture as a whole. All physical properties are and have been determined as described in “Merck Liquid Crystals, Physical Properties of Liquid Crystals”, Status November 1997, Merck KGaA, Germany, and apply to a temperature of 20° C., unless explicitly stated otherwise. Δn is determined at 589 nm and Δε at 1 kHz. The threshold voltages and the other electro-optical properties were determined in test cells produced at Merck KGaA, Germany, using white light in a commercial measuring instrument from Otsuka, Japan. To this end, cells were used, depending on Δn of the liquid crystals, with a thickness corresponding to the 1st Gooch and Tarry transmission minimum. The optical retardation d·Δn of the cells was thus about 0.32 μm. The cells were operated in so-called “normally white mode” with a polarizer transmission direction perpendicular to the respective adjacent rubbing directions. The characteristic voltages were all determined with perpendicular observation. The threshold voltage was given as V₁₀ for 10% relative contrast, the central limit voltage V₅₀ for 50% relative contrast and the saturation voltage V₉₀ for 90% relative contrast.

For the liquid-crystal media having negative dielectric anisotropy, the threshold voltage was determined as the capacitive threshold voltage V₀ (also known as the Freedericksz threshold) in cells containing liquids which had been homeotropically aligned by lecithin.

The liquid-crystal media according to the invention may, if necessary, also comprise further additives and chiral dopants in conventional amounts. The amount of these additives employed is in total from 0% to 10%, based on the total amount of mixture, preferably from 0.1% to 6%. The concentrations of the individual compounds employed are preferably from 0.1 to 3%. The concentration of these and similar additives is not taken into account when giving the concentrations and the concentration ranges of the liquid-crystal compounds in the liquid-crystal media.

The compositions consist of a plurality of compounds, preferably from 3 to 30, particularly preferably from 6 to 20, very particularly preferably from 10 to 16 compounds, which are mixed in a conventional manner. In general, the desired amount of the components used in lesser amount is dissolved in the components making up the principal constituent, expediently at elevated temperature. If the temperature selected is above the clearing point of the principal constituent, completion of the dissolution operation is particularly easily observed. However, it is also possible to prepare the liquid-crystal mixtures in other conventional ways, for example by using premixtures or from a so-called “multibottle system”.

By means of suitable additives, the liquid-crystal phases according to the invention can be modified in such a way that they can be employed in any type of TN-AMD that has been disclosed hitherto.

The entire disclosure of all applications, patents and publications, cited above, and of corresponding German Application No. DE 10020814.2, filed Apr. 28, 2000, is hereby incorporated by reference.

The examples below illustrate the invention without limiting it. In the examples, the melting point T (C,N), the transition from the smectic (S) to the nematic (N) phase T (S,N) and the clearing point T (N,I) of a liquid-crystal substance are given in degrees Celsius. Percentages are by weight.

Unless stated otherwise, all percentages above and below are percent by weight, and the physical properties are the values at 20° C., unless explicitly stated otherwise.

All temperature values given in this application are ° C. and all temperature differences are correspondingly difference degrees, unless explicitly stated otherwise.

In the present application and in the examples below, the structures of the liquid-crystal compounds are indicated by means of acronyms, the transformation into chemical formulae taking place in accordance with Tables A and B below. All radicals CₙH₂ₙ₊₁ and CₘH₂ₘ₊₁ are straight-chain alkyl radicals having n and m carbon atoms respectively. The coding in Table B is self-evident. In Table A, only the acronym for the parent structure is given. In individual cases, the acronym for the parent structure is followed, separated by a hyphen, by a code for the substituents R¹, R², L¹ and L²:

| Code for R¹, | | | | |
|---|---|---|---|---|
| R², L¹, L² | R¹ | R² | L¹ | L² |
| nm | CₙH₂ₙ₊₁ | CₘH₂ₘ₊₁ | H | H |
| nOm | CₙH₂ₙ₊₁ | OCₘH₂ₘ₊₁ | H | H |
| nO.m | OCₙH₂ₙ₊₁ | CₘH₂ₘ₊₁ | H | H |
| n | CₙH₂ₙ₊₁ | CN | H | H |
| nN.F | CₙH₂ₙ₊₁ | CN | H | F |
| nF | CₙH₂ₙ₊₁ | F | H | H |
| nOF | OCₙH₂ₙ₊₁ | F | H | H |
| nCl | CₙH₂ₙ₊₁ | Cl | H | H |
| nF.F | CₙH₂ₙ₊₁ | F | H | F |
| nF.F.F | CₙH₂ₙ₊₁ | F | F | F |
| nmF | CₙH₂ₙ₊₁ | CₘH₂ₘ₊₁ | H | F |
| nCF₃ | CₙH₂ₙ₊₁ | CF₃ | H | H |
| nOCF₃ | CₙH₂ₙ₊₁ | OCF₃ | H | H |
| nOCF₃.F | CₙH₂ₙ₊₁ | OCF₃ | H | F |
| nOCF₃F.F | CₙH₂ₙ₊₁ | OCF₃ | F | F |
| nOCF₂ | CₙH₂ₙ₊₁ | OCHF₂ | H | H |
| nOCF₂.F | CₙH₂ₙ₊₁ | OCHF₂ | H | F |
| nOCF₂.F.F | CₙH₂ₙ₊₁ | OCHF₂ | F | F |
| nS | CₙH₂ₙ₊₁ | NCS | H | H |
| nVsN | CᵣH₂ᵣ₊₁-CH═CH-C₅H₂ₛ | CN | H | H |
| nsN | CᵣH₂ᵣ₊₁-O-CₛH₂ₛ | CN | H | H |
| nAm | CₙH₂ₙ₊₁ | COOCₘH₂ₘ₊₁ | H | H |
| nCl.F | CₙH₂ₙ₊₁ | Cl | H | F |

TABLE A

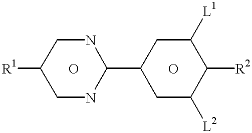

PYP

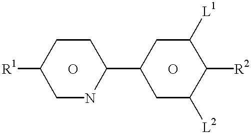

PYRP

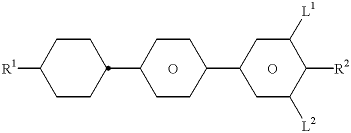

BCH

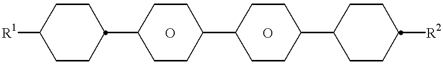

CBC

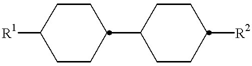

CCH

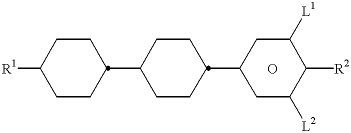

CCP

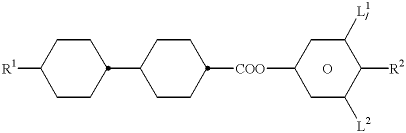

CP

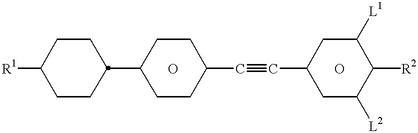

CPTP

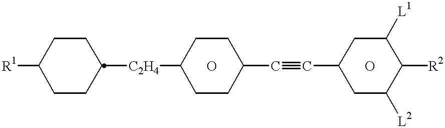

CEPTP

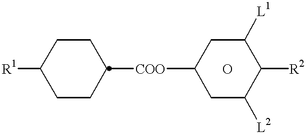

D

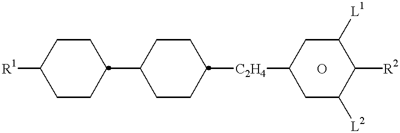

ECCP

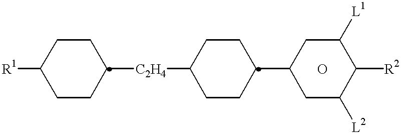

CECP

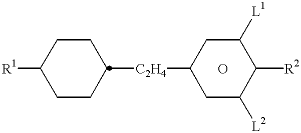

EPCH

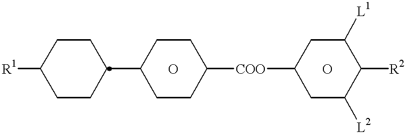

HP

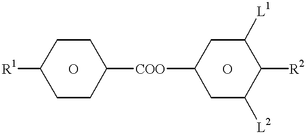

ME

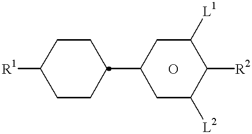

PCH

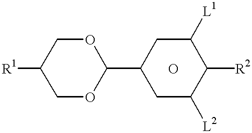

PDX

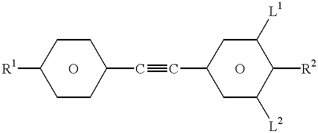

PTP

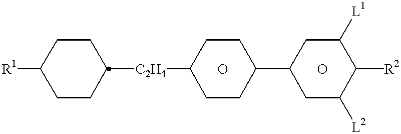

BECH

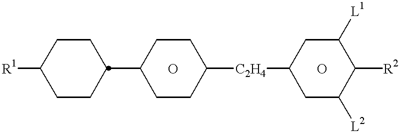

EBCH

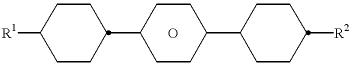

CPC

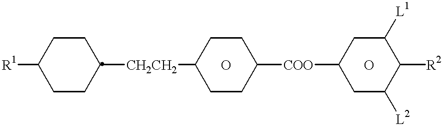

EHP

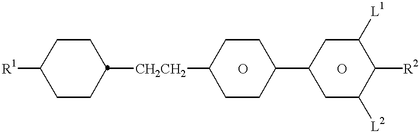

BEP

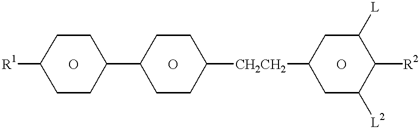

ET

TABLE B

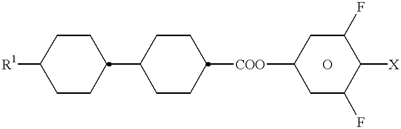

CCZU-n-X

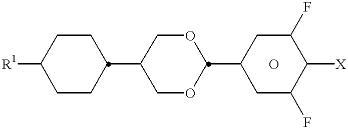

CDU-n-X

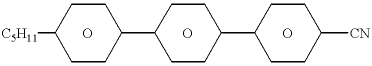

T15

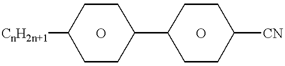

K3n

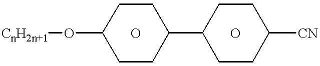

M3n

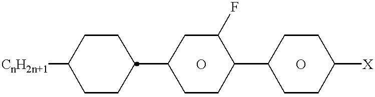

CGP-n-X

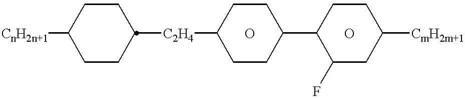

Inm

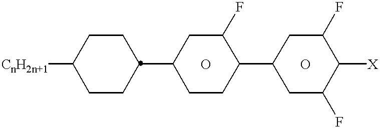

CGU-n-X

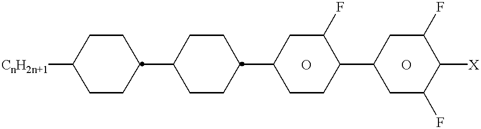

CCGU-n-X

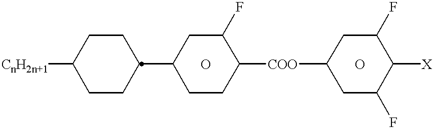

CGZU-n-X

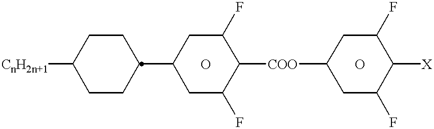

CUZU-n-X

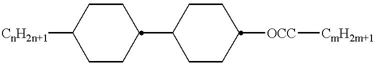

C-nm

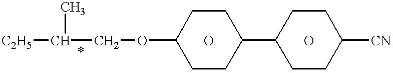

C15

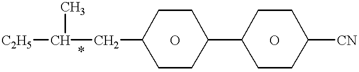

CB15

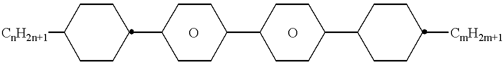

CBC-nm

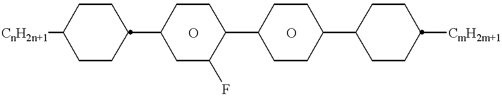

CBC-nmF

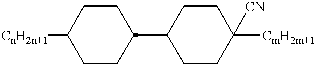

CCN-nm

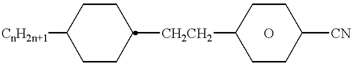

G3n

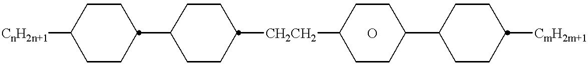

CCEPC-nm

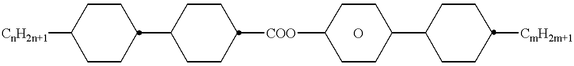

CCPC-nm

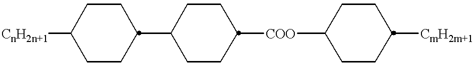

CH-nm

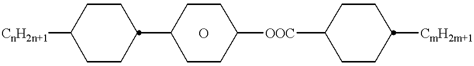

HD-nm

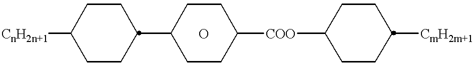

HH-nm

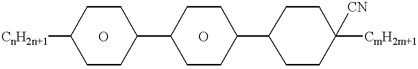

NCB-nm

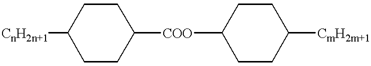

OS-nm

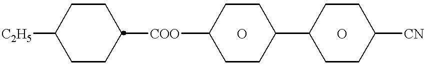

CHE

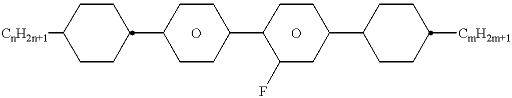

CBC-nmF

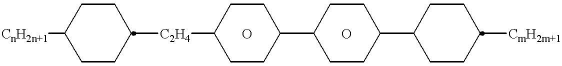

ECBC-nm

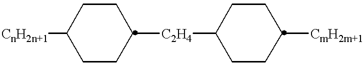

ECCH-nm

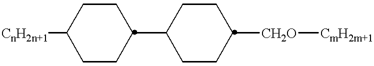

CCH-n1Em

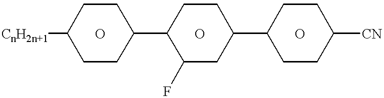

T-nFN

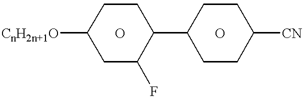

B-nO.FN

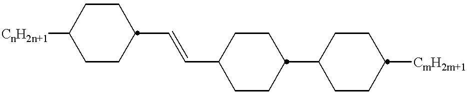

CVCC-n-m

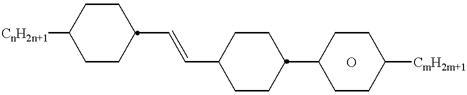

CVCP-n-m

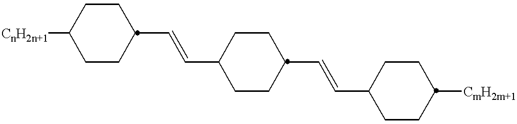

CVCVC-n-m

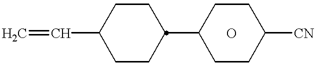

CP-V-N

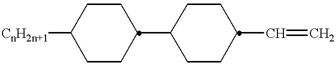

CC-n-V

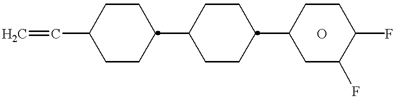

CCG-V-F

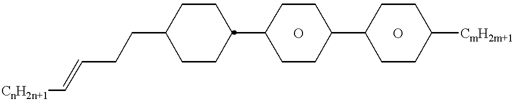

CPP-nV2-m

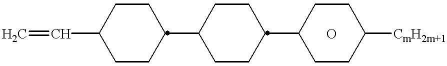

CCP-V-m

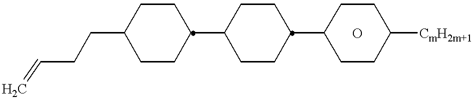

CCP-V2-m

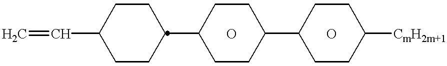

CPP-V-m

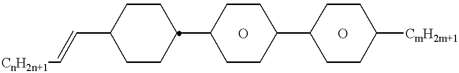

CPP-nV-m

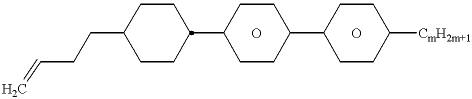

CPP-V2-m

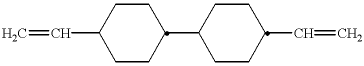

CC-V-V

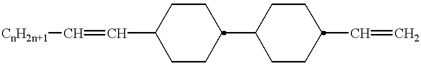

CC-nV-V

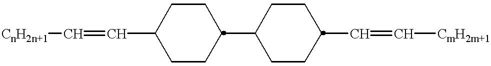

CC-nV-Vm

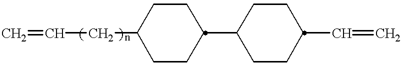

CC-Vn-V

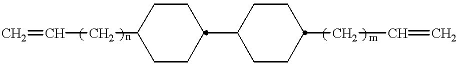

CC-Vn-mV

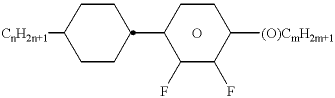

PCH-n(O)mFF

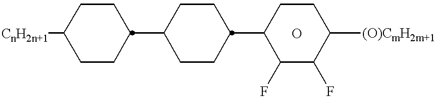

CCP-n(O)mFF

### EXAMPLES

The examples below are intended to illustrate the invention without representing a limitation. Above and below, percentages are percent by weight. All temperatures are given in degrees Celsius. Δn is the optical anisotropy (589 nm, 20° C.), Δε the dielectric anisotropy (1 kHz, 20° C.), H.R. the voltage holding ratio (at 100° C., after 5 minutes in an oven, 1 V), and V₁₀, V₅₀ and V₉₀ the threshold voltage, mid-grey voltage and saturation voltage respectively were determined at 20° C.

### Example 1

| Compound/ | Concentration/ | |
|---|---|---|
| abbreviation | % by mass | Properties |
| ME2N.F | 4.0 | Clearing point: T(N,I) = 66.0° C. |
| ME3N.F | 5.0 | Transition: T(S,N) <−30° C. |
| ME5N.F | 12.0 | nₑ (20° C., 589 nm) = 1.5670 |
| HP-3N.F | 7.0 | Δn (20° C., 589 nm) = 0.0873 |
| HP-4N.F | 8.0 | ε∥ (20° C., 1kHz) = 20.8 |
| CCH-301 | 11.0 | Δε (20° C., 1kHz) = 15.0 |
| CCH-303 | 16.0 | ν (20° C.,) = 26 cSt |
| CCH-501 | 13.0 | ν (0° C.,) = 90 cSt |
| CCH-502 | 12.0 | ν (−20° C.,) = 530 cSt |
| CH-33 | 4.0 | ν (−30° C.,) = 2200 cSt |
| CH-35 | 4.0 | V₁₀ (20° C.,) = 0.95 V |
| CH-45 | 4.0 | V₅₀ (20° C.,) = 1.21 V |
| Σ | 100.0 | V₉₀ (20° C.,) = 1.55 V |

The liquid-crystal medium was introduced into a VA HEF display with TFT addressing. This display had good contrast with low viewing-angle dependence and was virtually free from cross-talk between adjacent on and off pixels.

### Example 2

| Compound/ | Concentration/ | |
|---|---|---|
| abbreviation | % by mass | Properties |
| CCP-2F.F.F | 12.0 | Clearing point: T(N,I) = 75.0° C. |
| CCP-3F.F.F | 12.0 | Transition: T(S,N) <−20° C. |
| CCP-5F.F.F | 8.0 | nₑ (20° C., 589 nm) = 1.5652 |
| CCP-2OCF3 | 8.0 | Δn (20° C., 589 nm) = 0.0878 |
| CCP-3OCF3 | 8.0 | ε∥ (20° C., 1kHz) = 20.1 |
| CCP-5OCF3 | 7.0 | Δε (20° C., 1kHz) = 15.3 |
| CGU-2-F | 8.0 | |
| CGZU-2-F | 8.0 | |
| CGZU-3-F | 12.0 | V₁₀ (20° C.,) = 0.93 V |
| CGZU-5-F | 10.0 | V₅₀ (20° C.,) = 1.18 V |
| CCH-35 | 5.0 | V₉₀ (20° C.,) = 1.51 V |
| PCH-7F | 2.0 | |
| Σ | 100.0 | |

As in Example 1, the liquid-crystal medium was introduced into a VA HEF display with TFT addressing. This display has good contrast with low viewing-angle dependence and was virtually free from cross-talk between adjacent on and off pixels.

### Example 3

| Compound/ | Concentration/ | |
|---|---|---|
| abbreviation | % by mass | Properties |
| CCP-2F.F.F | 12.0 | Clearing point: (N,I) = 70.0° C. |
| CCP-3F.F.F | 12.0 | Transition: (S,N) <−20° C. |
| CCP-5F.F.F | 8.0 | nₑ (20° C., 589 nm) = 1.5652 |
| CCP-2OCF2.F.F | 4.0 | Δn (20° C., 589 nm) = 0.0888 |
| CCP-2OCF3 | 8.0 | ε∥ (20° C., 1kHz) = 20.5 |
| CCP-3OCF3 | 8.0 | Δε (20° C., 1kHz) = 15.4 |
| CCP-50CF3 | 8.0 | |
| CUZU-2-F | 10.0 | V₁₀ (20° C.,) = 0.91 V |
| CUZU-3-F | 10.0 | V₅₀ (20° C.,) = 1.15 V |
| CUZU-5-F | 10.0 | V₉₀ (20° C.,) = 1.48 V |
| CGU-3-F | 10.0 | |
| Σ | 100.0 | |

As in Example 1, the liquid-crystal medium was introduced into a VA HEF display with TFT addressing. This display has good contrast with low viewing-angle dependence and was virtually free from cross-talk between adjacent on and off pixels.

### Example 4

| Compound/ | Concentration/ | |
|---|---|---|
| abbreviation | % by mass | Properties |
| ME2N.F | 2.0 | Clearing point: (N,I) = 65.0° C. |
| ME3N.F | 2.0 | Transition: (S,N) <−30° C. |
| CCZU-2-F | 7.0 | nₑ (20° C., 589 nm) = 1.5653 |
| CCZU-3-F | 15.0 | Δn (20° C., 589 nm) = 0.0880 |
| CCZU-5-F | 7.0 | ε∥ (20° C., 1kHz) = 23.7 |
| PCH-3N.F.F | 13.0 | Δε (20° C., 1kHz) = 16.5 |
| CCH-3 | 5.0 | |
| PDX-3 | 14.0 | V₁₀ (20° C.,) = 0.84 V |
| PDX-5 | 12.0 | V₅₀ (20° C.,) = 1.03 V |
| CCP-3OCF3 | 8.0 | V₉₀ (20° C.,) = 1.34 V |
| CCP-5OCF3 | 7.0 | |
| CCH-33 | 5.0 | |
| CCPC-35 | 3.0 | |
| Σ | 100.0 | |

As in Example 1, the liquid-crystal medium was introduced into a VA HEF display with TFT addressing. This display has good contrast with low viewing-angle dependence and was virtually free from cross-talk between adjacent on and off pixels.

### Example 5

| Compound/ | Concentration/ | |
|---|---|---|
| abbreviation | % by mass | Properties |
| PCH-3N.F.F | 14.0 | Clearing point: (N,I) = 68.0° C. |
| CCZU-2-F | 5.0 | Transition: (S,N) <−20° C. |
| CCZU-3-F | 19.0 | nₑ (20° C., 589 nm) = 1.5727 |
| CCZU-5-F | 5.0 | Δn (20° C., 589 nm) = 0.0894 |
| CGU-2-F | 8.0 | ε∥ (20° C., 1kHz) = 24.1 |
| CGU-3-F | 10.0 | Δε (20° C., 1kHz) = 17.5 |
| CGU-5-F | 5.0 | |
| CCPC-33 | 4.0 | V₁₀ (20° C.,) = 0.90 V |
| CCPC-34 | 3.0 | V₅₀ (20° C.,) = 1.11 V |
| CCP-2F.F.F | 5.0 | V₉₀ (20° C.,) = 1.41 V |
| CCP-3F.F.F | 12.0 | |
| CCP-5F.F.F | 5.0 | |
| ME2N.F | 2.0 | |
| ME3N.F | 3.0 | |
| Σ | 100.0 | |

As in Example 1, the liquid-crystal medium was introduced into a VA HEF display with TFT addressing. This display has good contrast with low viewing-angle dependence and was virtually free from cross-talk between adjacent on and off pixels.

### Example 6

| Compound/ | Concentration/ | |
|---|---|---|
| abbreviation | % by mass | Properties |
| PCH-3N.F.F | 14.0 | Clearing point: (N,I) = 65.0° C. |
| CCZU-2-F | 5.0 | Transition: (S,N) <−20° C. |
| CCZU-3-F | 19.0 | nₑ (20° C., 589 nm) = 1.5710 |
| CCZU-5-F | 5.0 | Δn (20° C., 589 nm) = 0.0877 |
| CGU-2-F | 8.0 | ε∥ (20° C., 1kHz) = 24.0 |
| CGU-3-F | 10.0 | Δε (20° C., 1kHz) = 17.3 |
| CGU-5-F | 3.0 | |
| CCPC-33 | 4.0 | V₁₀ (20° C.,) = 0.92 V |
| CCPC-34 | 2.0 | V₅₀ (20° C.,) = 1.12 V |
| CCP-2F.F.F | 8.0 | V₉₀ (20° C.,) = 1.42 V |
| CCP-3F.F.F | 11.0 | |
| CCP-5F.F.F | 4.0 | |
| ME2N.F | 2.0 | |
| ME3N.F | 3.0 | |
| CCGU-3-F | 2.0 | |
| Σ | 100.0 | |

As in Example 1, the liquid-crystal medium was introduced into a VA HEF display with TFT addressing. This display has good contrast with low viewing-angle dependence and was virtually free from cross-talk between adjacent on and off pixels.

### Example 7

| Compound/ | Concentration/ | |
|---|---|---|
| abbreviation | % by mass | Properties |
| PCH-3N.F.F | 16.0 | Clearing point: (N,I) = 67.0° C. |
| CCZU-2-F | 5.0 | Transition: (S,N) <−20° C. |
| CCZU-3-F | 19.0 | nₑ (20° C., 589 nm) = 1.5669 |
| CCZU-5-F | 5.0 | Δn (20° C., 589 nm) = 0.0856 |
| CGU-2-F | 4.0 | ε∥ (20° C., 1kHz) = 23.6 |
| CGU-3-F | 7.0 | Δε (20° C., 1kHz) = 16.6 |
| CGU-5-F | 2.0 | |
| CCPC-33 | 4.0 | V₁₀ (20° C.,) = 0.94 V |
| CCPC-34 | 2.0 | V₅₀ (20° C.,) = 1.15 V |
| BCH-3F.F.F | 7.0 | V₉₀ (20° C.,) = 1.46 V |
| CCGU-3-F | 6.0 | |
| CDU-2-F | 7.0 | |
| CDU-3-F | 10.0 | |
| CDU-5-F | 6.0 | |
| Σ | 100.0 | |

As in Example 1, the liquid-crystal medium was introduced into a VA HEF display with TFT addressing. This display has good contrast with low viewing-angle dependence and was virtually free from cross-talk between adjacent on and off pixels.

### Example 8

| Compound/ | Concentration/ | |
|---|---|---|
| abbreviation | % by mass | Properties |
| CCZU-2-F | 5.0 | Clearing point: (N,I) = 67.0° C. |
| CCZU-3-F | 19.0 | Transition: (S,N) <−20° C. |
| CCZU-5-F | 5.0 | nₑ (20° C., 589 nm) = 1.5751 |
| CCPU-V-1 | 3.0 | Δn (20° C., 589 nm) = 0.0892 |
| CC-5-V | 18.0 | ε∥ (20° C., 1kHz) = 27.1 |
| CDU-2-F | 10.0 | Δε (20° C., 1kHz) = 20.4 |
| CDU-5-F | 7.0 | |
| CP-3OCF3 | 4.0 | V₁₀ (20° C.,) = 0.75 V |
| ME2N.F | 6.0 | V₅₀ (20° C.,) = 0.94 V |
| ME3N.F | 6.0 | V₉₀ (20° C.,) = 1.24 V |
| ME4N.F | 11.0 | |
| CCG-V-F | 6.0 | |
| Σ | 100.0 | |

As in Example 1, the liquid-crystal medium was introduced into a VA HEF display with TFT addressing. This display has good contrast with low viewing-angle dependence and was virtually free from cross-talk between adjacent on and off pixels.

### Example 9

| Compound/ | Concentration/ | |
|---|---|---|
| abbreviation | % by mass | Properties |
| CCP-2F.F.F | 11.0 | Clearing point (N, I) = 70.5° C. |
| CCP-3F.F.F | 11.0 | Transition (S, N) < −40° C. |
| CCP-20CF3.F | 5.0 | nₑ (20° C., 589 nm) = 1.5680 |
| CGU-2-F | 11.0 | Δn (20° C., 589 nm) = 0.0896 |
| CGU-3-F | 11.0 | ε_{∥} (20° C., 1 kHz) = 19.1 |
| CGU-5-F | 4.0 | Δε (20° C., 1 kHz) = 14.2 |
| CCZU-2-F | 6.0 | |
| CCZU-3-F | 15.0 | V₁₀ (20° C.) = 1.00 V |
| CCZU-5-F | 6.0 | V₅₀ (20° C.) = 1.22 V |
| CPZG-2-0T | 6.0 | V₉₀ (20° C.) = 1.56 V |
| CPZG-3-0T | 7.0 | |
| CC-3-V1 | 7.0 | |
| Σ | 100.0 | |

As in Example 1, the liquid-crystal medium was introduced into a VA HEF display with TFT addressing. This display has good contrast with low viewing-angle dependence and was virtually free from cross-talk between adjacent on and off pixels.

### Comparative Example 1

| Compound/ | Concentration/ | |
|---|---|---|
| abbreviation | % by mass | Properties |
| ME2N.F | 3.0 | Clearing point: T (N, T) = 70.0° C. |
| ME3N.F | 4.0 | Transition: T (S, N) < −40° C. |
| PDX-3 | 11.0 | nₑ (20° C., 589 nm) = 1.5692 |
| PDX-4 | 10.0 | Δn (20° C., 589 nm) = 0.0880 |
| HP-3N.F | 2.0 | ε_{∥} (20° C., 1 kHz) = 15.6 |
| HP-5N.F | 5.0 | Δε (20° C., 1 kHz) = 9.9 |
| PYP-5F | 10.0 | ν (20° C.) = 23 cSt |
| CCH-301 | 10.0 | ν (0° C.) = 72 cSt |
| CCH-303 | 12.0 | ν (−20° C.) = 400 cSt |
| CCH-502 | 11.0 | ν (−30° C.) = 1400 cSt |
| CH-33 | 4.0 | ν (−30° C.) = 6500 cSt |
| CH-35 | 4.0 | |
| CH-43 | 4.0 | V₁₀ (20° C.) = 1.24 V |
| CH-53 | 4.0 | V₅₀ (20° C.) = 1.50 V |
| CCPC-33 | 4.0 | V₉₀ (20° C.) = 1.87 V |
| CCPC-35 | 4.0 | |
| Σ | 100.0 | |

As in Example 1, the liquid-crystal medium was introduced into a VA HEF display with TFT addressing. This display does not have a good contrast since Δε was too small. It is already evident from a comparison of the saturation voltages V₉₀ of the present mixture with those of the other Examples that the driving voltage required to reach the saturation value of the contrast was too high for most applications.

1. A liquid-crystal medium which comprises
one or more strongly dielectrically positive compound(s) selected from the group of the compounds of the formulae I to III 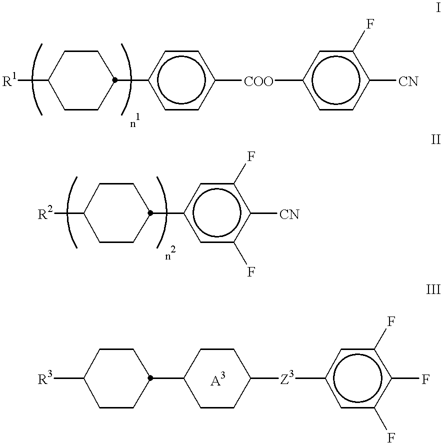
in which
R¹, R² and R³ are each, independently of one another, alkyl or alkoxy having 1 to 7 carbon atoms, or alkenyl, alkoxyalkyl or alkenyloxy having 2 to 7 carbon atoms,
n¹ is 0 or 1,
n² is 1 or 2, and

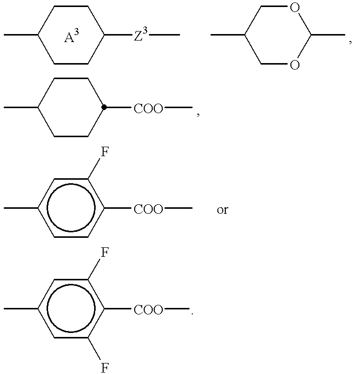

2. The liquid-crystal medium according to claim 1, which further comprises:
one or more dielectrically positive compound(s) of the formula IV 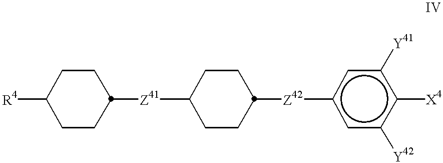
in which
R⁴ is as defined in claim 1 for R¹ under the formula I, and
Z⁴¹ is —CH₂—CH₂—, —CF₂—O—, —O—CF₂— or a single bond,
Z⁴² is —COO—, —CH₂—CH₂—, —CF₂—O—, —O—CF₂— or a single bond,
X⁴ is F, Cl, OCF₂H or OCF₃, and
Y⁴¹ and Y⁴² are each, independently of one another, H or F,
where, in the case where X⁴=F, preferably at least one of Y⁴¹ and Y⁴² is F
and/or
one or more dielectrically positive compound(s) of the formula V 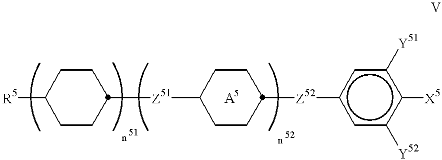
in which
R⁵ is as defined in claim 1 for R¹ under the formula I, and
Z⁵¹ and Z⁵² are each, independently of one another, —CH₂CH₂— or a single bond, 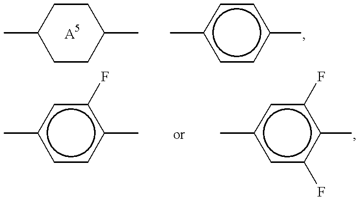
n⁵² is 0 or 1,
n⁵¹ is 1 and, in the case where n⁵²=1, can also be 2.

3. A liquid-crystal medium according to claim 1 which comprises one or more compound(s) of the formula I.

4. A liquid-crystal medium according to claim 2 which comprises one or more compound(s) of the formula I.

5. A liquid-crystal medium according to claim 1, which comprises one or more dielectrically positive compound(s) of the formula III.

6. A liquid-crystal medium according to claim 1, which further comprises one or more dielectrically positive compound(s) of the formula VI 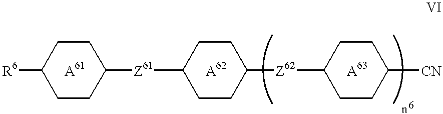
in which
R⁶ is as defined above for R¹ under the formula I and
Z⁶¹ and Z⁶² are each, independently of one another, —CH₂CH₂—, —COO— or a single bond, 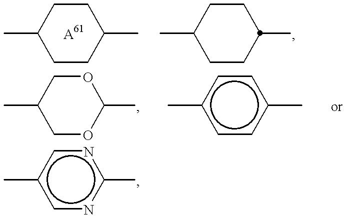 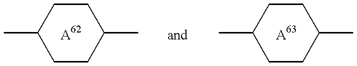
are each, independently of one another, 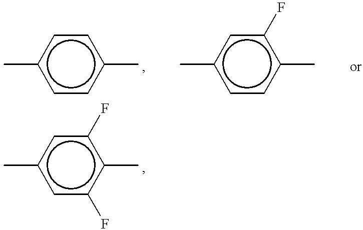
n⁶ is 0 or 1.

7. A liquid-crystal medium according to claim 1, which further comprises one or more dielectrically neutral compound(s) selected from the group consisting of the compounds of the formulae VII and VIII 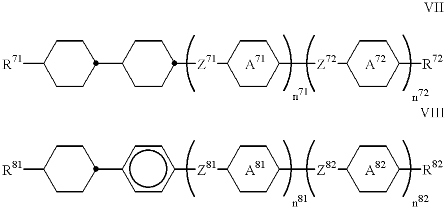
in which
R⁷¹ and R⁷² are each, independently of one another, as defined above for R¹ under the formula I, and
Z⁷¹ and Z⁷² are each, independently of one another, —COO—, —CH₂CH₂— or a single bond, 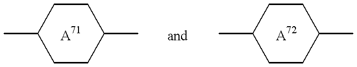
are each, independently of one another, 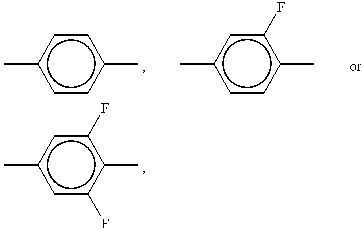
if present, at least one being 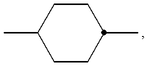
R⁸¹ and R⁸² are each, independently of one another, as defined above for R¹ under the formula I, and
n⁷¹ and n⁷² are each, independently of one another, 0 or 1;
Z⁸¹ and Z⁸² are each, independently of one another, —COO—, —CH₂CH₂— or a single bond, 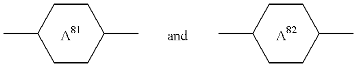
are each, independently of one another, 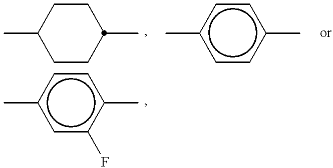
and
n⁸¹ and n⁸² are each, independently of one another, 0 or 1,
the compounds of the formula VII being excluded from inclusion in the compounds of formula VIII.

8. A liquid-crystal medium according to claim 7, characterized in that it comprises in total
from 20% to 50% of compounds of the formula I,
from 50% to 75% of compounds of the formula VII, and
from 0% to 10% of one or more other compounds which are not covered by the formulae I and VII.

9. An electro-optical display containing a liquid-crystal medium according to claim 1.

10. An electro-optical display according to claim 9, which is a VA display having an essentially horizontal electric field.

11. The liquid-crystal medium of claim 1, wherein for formula I, II and III, R¹, R² and R³ are each independently n-alkyl or n-alkoxy of 1 to 5 carbon atoms or 1E-alkenyl, unbranched alkoxylalkyl or alkenyloxy of 2 to 4 carbon atoms.

12. The liquid-crystal medium of claim 2, wherein for formula IV, X⁴ is F and, when X=F at least one of Y⁴¹ and Y⁴² is F; and for formula V Z⁵¹ and Z⁵² are independently [chemical structure]
